(19) United States
(12) Patent Application Publication
(10) Pub. No.: US 2015/0334918 A1
(43) Pub. Date: Nov. 26, 2015

(54) HYDRAULIC DRIVE AND BRAKING CIRCUIT FOR A MATERIAL REDUCING APPARATUS

(71) Applicant: Vermeer Manufacturing Company, Pella, IA (US)

(72) Inventor: Stephen Daining, Pella, IA (US)

(21) Appl. No.: 14/719,573

(22) Filed: May 22, 2015

Related U.S. Application Data
(60) Provisional application No. 62/002,515, filed on May 23, 2014.

(51) Int. Cl. A01D 69/03; F15B 1/04; A01D 34/60

(52) U.S. Cl. CPC A01D 69/03; A01D 34/60; F15B 1/04

(57) ABSTRACT

A material reducing apparatus is provided. The material reducing apparatus includes a hydraulic pump, a rotary reducing component, a primary hydraulic circuit, and a secondary hydraulic circuit. The primary hydraulic circuit includes a hydraulic motor that drives rotation of the rotary reducing component, an inlet line for delivering pressurized hydraulic fluid to an inlet of the hydraulic motor, and an outlet line for receiving the hydraulic fluid from an outlet of the hydraulic motor. The primary hydraulic circuit also includes at least one braking valve in fluid communication with the outlet line of the hydraulic motor, and a hydraulic accumulator in fluid communication with the inlet line. The hydraulic accumulator is sized to contain a stored volume of pressurized hydraulic fluid. The secondary hydraulic circuit includes an actuator that is selectively driven by pressurized hydraulic fluid from the hydraulic pump.

### CROSS REFERENCE TO RELATED APPLICATIONS

This application claims the benefit of U.S. Provisional Application Ser. No. 62/002,515, filed May 23, 2014, which application is hereby incorporated by reference in its entirety.

### TECHNICAL FIELD

The present disclosure relates generally to machines for reducing material. In particular, the present disclosure relates to material reducing machines that include hydraulic drive and braking circuits.

### BACKGROUND

Material reducing machines are machines used to reduce the size of material by processes such as mulching, chipping, grinding, cutting, or like actions. A typical material reducing machine includes a rotary reducing component that reduces material as the material reducing component rotates about a central axis. In certain examples, the rotary reducing component works in combination with other structures such as screens or anvils to facilitate the material reduction process. In certain examples, the rotary reducing component includes a main rotating body (e.g., a rotor, drum, plate stack, or like structures) and a plurality of reducing elements (e.g., knives, cutters, blades, hammers, teeth, or like structures) carried by the main rotating body. In certain examples, the reducing elements are positioned about a circumference of the main rotating body and are configured to define a circular cutting boundary as the rotary reducing component is rotated about its central axis.

A forestry mower is an example of one type of material reducing machine. A forestry mower typically includes a vehicle such as a tractor or skid-steer vehicle. A material reducing head is coupled to the vehicle (e.g., by a pivot arm or boom). The material reducing head includes a rotary reducing component often including a rotating drum that carries a plurality of reducing blades. The material reducing head can be raised and lowered relative to the vehicle, and can also be pivoted/tilted forwardly and backwardly relative to the vehicle. By raising the reducing head and tilting the reducing head back, the forestry mower can be used to strip branches from trees and other aerial applications. By lowering the reducing head and pivoting the reducing head forward, the forestry mower can readily be used to clear brush, branches, and other material along the ground.

In forestry mowers, it is common to use a hydraulic drive system for rotating the drum carrying the reducing blades. The rotating drum is typically quite heavy and, therefore, has a substantial amount of inertia when rotated at high speeds. In view of the inertia associated with the rotating drum, it is common for forestry mowers to use a hydraulic braking circuit to quickly stop rotation of the drum when the hydraulic drive is deactivated or slowed down by the operator. U.S. Pat. No. 7,621,112 discloses a forestry machine including a hydraulic drive system for driving rotation of the drum and for providing drum braking.

### SUMMARY

One aspect of the present disclosure relates to a rotary reducing apparatus including a rotary reducing component. The rotary reducing apparatus also includes a hydraulic system for driving rotation of the rotary reducing component and for providing hydraulic braking of the rotary reducing component. The hydraulic system includes a hydraulic pump, a hydraulic motor powered by the hydraulic pump for driving rotation of the rotary reducing component, and at least one actuator in addition to the hydraulic motor. The actuator(s) can be in a parallel hydraulic circuit with the hydraulic motor. In certain examples, the actuator can include a lift or tilt actuator (e.g., a lift or tilt hydraulic cylinder) of a forestry mower. The hydraulic system further includes an accumulator that provides make-up flow to an inlet side of the hydraulic motor when the hydraulic motor is driven concurrently with the actuator. In certain examples, this type of arrangement prevents unintentional braking of the hydraulic motor when the actuator is actuated while the rotary reducing component is being used for reducing operations. In certain examples, this type of arrangement allows the hydraulic pump to be sized to provide a maximum flow rate that is relatively close to the peak demand of the hydraulic motor during reducing operations without sacrificing performance when the hydraulic motor and the actuator(s) are operated concurrently.

A material reducing apparatus may be provided. The material reducing apparatus may include a hydraulic pump, a rotary reducing component, a primary hydraulic circuit, and a secondary hydraulic circuit. The primary hydraulic circuit may include a hydraulic motor that drives rotation of the rotary reducing component, an inlet line for delivering pressurized hydraulic fluid to an inlet of the hydraulic motor, and an outlet line for receiving the hydraulic fluid from an outlet of the hydraulic motor. The primary hydraulic circuit may also include at least one braking valve in fluid communication with the outlet line of the hydraulic motor, and a hydraulic accumulator in fluid communication with the inlet line. The hydraulic accumulator may be sized to contain a stored volume of pressurized hydraulic fluid. The secondary hydraulic circuit may be in parallel with the primary hydraulic circuit and may include at least one actuator that is selectively driven by pressurized hydraulic fluid from the hydraulic pump.

Preventing unintentional braking of a hydraulic motor when a secondary load is applied to a hydraulic pump while the hydraulic pump is concurrently driving a primary load may be provided. Hydraulic fluid pressurized by the hydraulic pump may be delivered to an inlet of the hydraulic motor and discharged at an outlet line extending from an outlet of the hydraulic motor. The inlet of the hydraulic motor is in fluid communication with a hydraulic accumulator sized to contain a stored volume of pressurized hydraulic fluid. Hydraulic fluid pressurized by the hydraulic pump may be delivered to at least one actuator that corresponds to the secondary load. The accumulator can be sized and configured to provide sufficient hydraulic fluid flow and pressure to the inlet side of the hydraulic motor to prevent unintentional braking of the hydraulic motor when the secondary load is being applied to the hydraulic pump.

A variety of additional aspects will be set forth in the description that follows. The aspects can relate to individual features and to combinations of features. It is to be understood that both the forgoing general description and the following detailed description are exemplary and explanatory only and are not restrictive of the broad concepts upon which the examples disclosed herein are based.

### BRIEF DESCRIPTION OF THE DRAWINGS

The accompanying drawings, which are incorporated in and constitute a part of this disclosure, illustrate various embodiments of the present disclosure. In the drawings:

FIGS. 1A and 1B illustrate a material reducing apparatus in accordance with the principles of the present disclosure;

FIG. 2 illustrates an example hydraulic system operating in a normal mode corresponding to normal reducing operations of the material reducing apparatus;

FIG. 3 illustrates the hydraulic system when hydraulic braking has first been initiated;

FIG. 4 illustrates the hydraulic system in a full hydraulic braking mode;

FIG. 5 illustrates the hydraulic circuit wherein an actuator of a secondary hydraulic circuit is in an open mode;

FIG. 6 illustrates an example hydraulic system wherein the actuator of the secondary hydraulic circuit is in a second open mode; and

FIG. 7 is a flow chart illustrating an example method in accordance with the principles of the present disclosure.

### DETAILED DESCRIPTION

The present disclosure relates generally to a material reducing apparatus having a rotary reducing component. The rotary reducing component is driven and braked by a hydraulic system. The hydraulic system includes a hydraulic motor for rotating the rotary reducing component. The hydraulic system also includes a hydraulic pump for driving the hydraulic motor. The hydraulic motor represents a primary load on the hydraulic pump, and the output hydraulic pump can be sized to generally match the peak flow demand required by the hydraulic motor. The hydraulic system also powers one or more actuators that represent a secondary load on the hydraulic motor. The one or more actuators can be part of a secondary hydraulic circuit that is arranged in parallel with respect to the hydraulic circuit corresponding to the hydraulic motor. The hydraulic system further includes a hydraulic braking arrangement for increasing the hydraulic pressure at an output side of the hydraulic motor to provide a braking effect. In certain examples, the hydraulic braking can be provided by one or more valves such as a counterbalance valve and/or a relief valve. In the case of the counterbalance valve, the counterbalance valve can receive pilot pressure from an input side of the hydraulic motor. In the case of the relief valve, the relief valve can be configured to allow hydraulic fluid flow from the outlet side of the hydraulic motor to the inlet side of the hydraulic motor when the outlet side of the hydraulic motor exceeds a predetermined pressure.

The hydraulic system can further include an arrangement that prevents unintentional braking of the hydraulic motor when the secondary load is applied to the hydraulic pump while the hydraulic pump is concurrently driving the primary load. In certain examples, a hydraulic accumulator can be used to provide hydraulic fluid flow and hydraulic pressure to the inlet side of the motor to prevent such unintentional braking. It will be appreciated that such unintentional braking takes place when the diversion of hydraulic fluid and pressure to the secondary load causes the hydraulic pressure at the inlet side of the hydraulic motor to drop below a predetermined level. The accumulator provides make-up pressure and hydraulic fluid that prevents such drops in hydraulic fluid pressure at the inlet side of the motor from occurring when hydraulic fluid and pressure is being diverted to the secondary load. In certain examples, the secondary load can be an actuator such as a hydraulic cylinder used to perform additional functions (e.g., lifting and lowering a reducing head, tilting a reducing head, raising and lowering a push bar, or like functions) of the material reducing apparatus.

Certain aspects of the present disclosure relate to a hydraulic braking and drive circuit for a rotary reducing component. The hydraulic drive and braking circuit includes an accumulator that provides supplemental hydraulic fluid flow and pressure for driving the rotary reducing component when a secondary load is applied to the hydraulic circuit. In certain examples, the accumulator has a volume that is at least 20% of a maximum actuation volume of the largest secondary load arranged in parallel with the hydraulic braking and drive circuit. In certain examples, the secondary load corresponds to one or more hydraulic cylinders, and the maximum actuation flow volume equals the volume required to move the hydraulic cylinder or cylinders from a fully retracted state to a fully extended state. In certain examples, the accumulator is sized in relation to a hydraulic motor used to drive rotation of the rotary reducing component. In one example, the accumulator is sized to have a volume that is at least ten times as large as a maximum displacement value of the hydraulic motor.

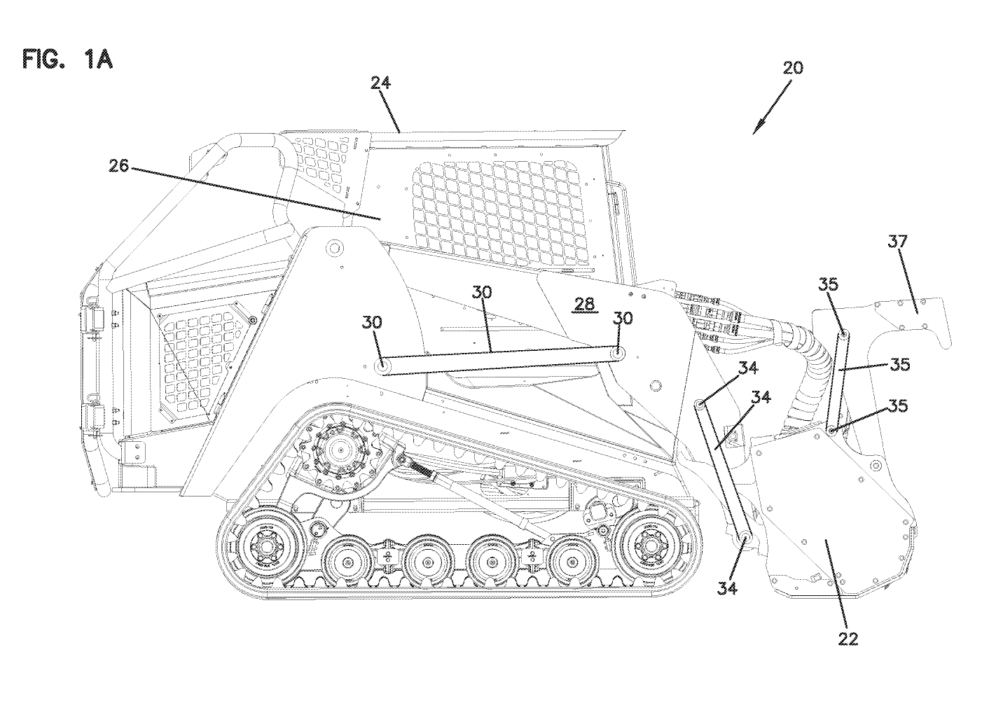

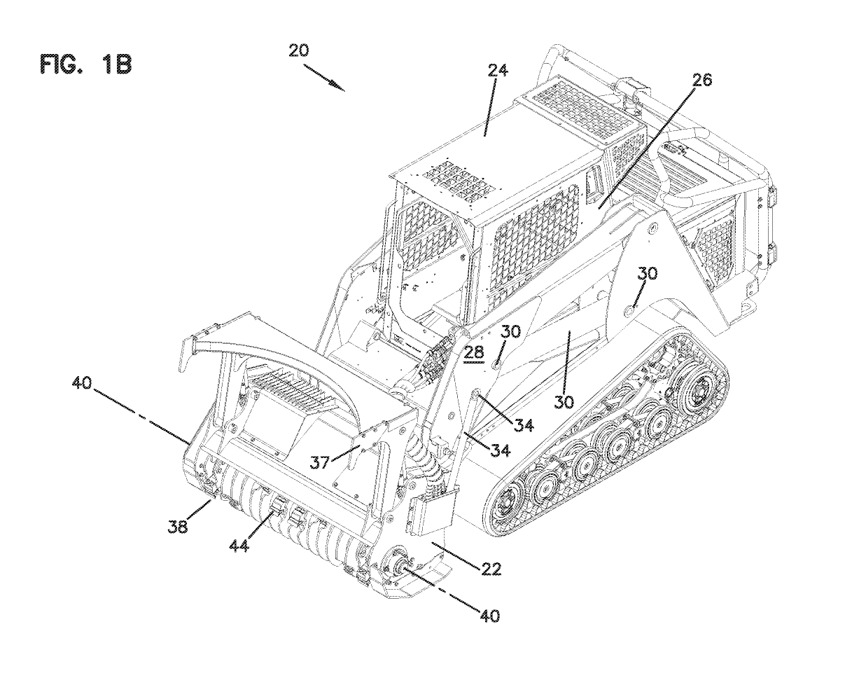

FIGS. 1A and 1B illustrate a material reducing apparatus in accordance with the principles of the present disclosure. As depicted, the material reducing apparatus is shown as a forestry machine 20 including a material reducing head 22 carried by a vehicle 24. The vehicle 24 is depicted as a skid-steer loader, but could be any other type of vehicle, such as a wheeled or tracked tractor. The vehicle 24 includes a main frame 26. A linkage (e.g., a boom 28 including a boom arm, a pair of spaced-apart boom arms, or other structures) connects the material reducing head 22 to the frame 26 of the vehicle 24. Cylinders 30 (e.g., a pair of boom cylinders) can be used to pivot the boom 28 up and down to raise and lower the material reducing head 22 relative to the frame 26. Hydraulic cylinders 34 (e.g., a pair of head cylinders) can be used to pivot the material reducing head 22 to tilt the material reducing head 22 forwardly and rearwardly relative to the frame 26. Hydraulic cylinders 35 (e.g., a pair of push bar cylinders) can be used to raise and lower a push bar 37 of the forestry machine 20.

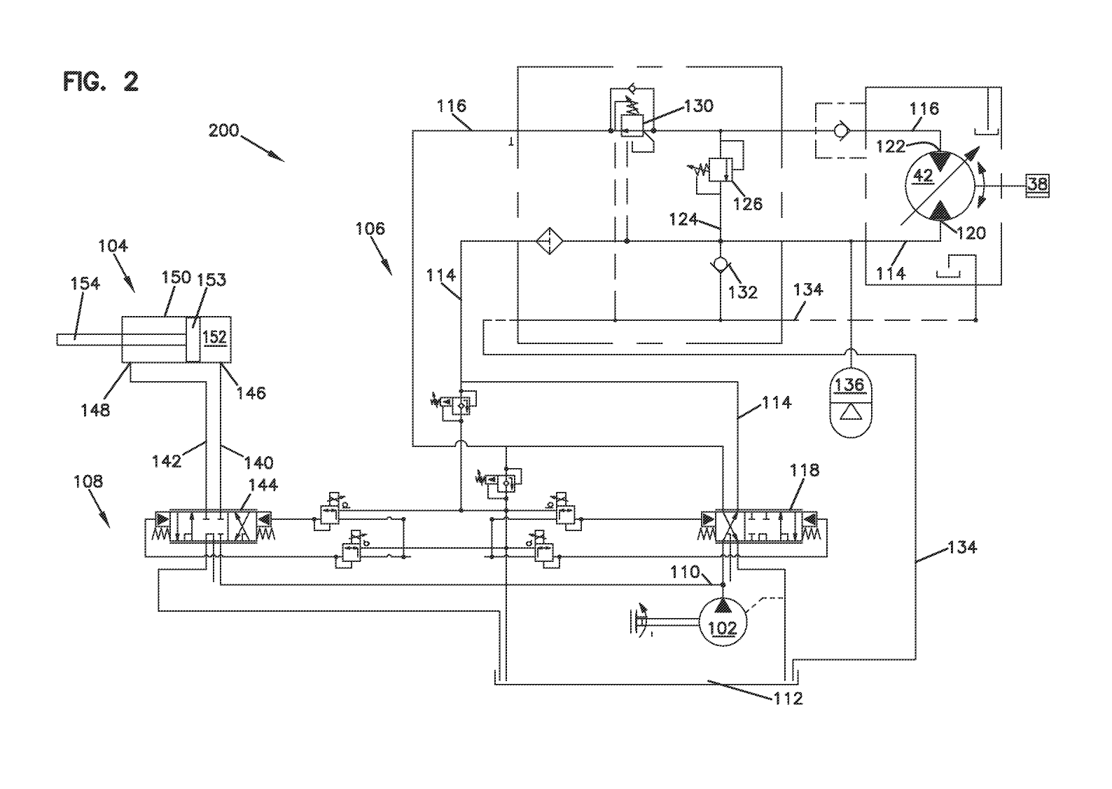

The material reducing head 22 includes a rotary reducing component 38 that is rotated about a central axis 40. At least one hydraulic motor 42 (see schematic representation at FIG. 2) can be provided for rotating the rotary reducing component 38 about the central axis 40. The rotary reducing component 38 can include a drum or other main body which carries a plurality of reducing elements 44 (e.g., blades).

FIG. 2 shows an example hydraulic system 200 operating in a normal mode corresponding to normal reducing operations of the material reducing apparatus in accordance with the principles of the present disclosure. The hydraulic system 200 is suitable for use with a material reducing apparatus such as the forestry machine 20 of FIG. 1. The hydraulic system 200 includes a hydraulic motor 42 for driving the rotary reducing component 38. The hydraulic motor 42 is driven by a hydraulic pump 102. The hydraulic motor 42 represents a primary load of the hydraulic system 200. The hydraulic system 200 also includes an actuator 104 that is also powered by the hydraulic pump 102. The actuator 104 represents a secondary load on the hydraulic pump 102. In certain examples, the actuator 104 is representative of one or more hydraulic cylinders present in a secondary hydraulic circuit powered by the hydraulic pump, the secondary hydraulic circuit being parallel to the primary hydraulic circuit. Example hydraulic cylinders include the lift hydraulic cylinders 30, the tilt hydraulic cylinders 34, or the push bar hydraulic cylinders 35 of the forestry machine 20.

The hydraulic system 200 includes a primary hydraulic circuit 106 corresponding to the hydraulic motor 42 and a secondary hydraulic circuit 108 corresponding to the secondary load. The secondary hydraulic circuit 108 is arranged in parallel with the primary hydraulic circuit 106. A number of separate secondary hydraulic circuits arranged in parallel with the primary hydraulic circuit can be provided for each of the secondary loads (e.g., separate secondary parallel circuits can be provided for the lift cylinders 30, for the tilt cylinders 30, and for the push bar cylinders 35). The hydraulic pump 102 powers the primary and secondary circuits and includes a high pressure side 110 that fluidly couples to the circuits 106, 108 to provide hydraulic fluid pressure and flow to the circuits 106, 108. The hydraulic pump 102 also has a low pressure side fluidly coupled to tank 112.

The primary hydraulic circuit 106 includes a motor inlet line 114 and a motor outlet line 116. The motor inlet line 114 extends from a control valve 118 to an inlet 120 of the hydraulic motor 42. The motor outlet line 116 extends from the control valve 118 to an outlet 122 of the hydraulic motor 42. The primary hydraulic circuit 106 further includes a relief line 124 that extends between the motor inlet line 114 and the motor outlet line 116. A relief valve 126 is positioned along the relief line 124 and controls flow through the relief line 124 between the motor inlet line 114 and the motor outlet line 116. The relief valve 126 blocks flow through the relief line 124 until the pressure at the motor outlet line 116 exceeds a predetermined pressure value. In one example, the predetermined pressure value is 2500 pounds per square inch. When the pressure at the motor outlet line 116 exceeds the predetermined value, the relief valve 126 is forced open thereby allowing hydraulic fluid to flow from the motor outlet line 116 to the motor inlet line 114.

The primary hydraulic circuit 106 further includes a counterbalance valve 130 positioned along the motor outlet line 116 at a location downstream from the relief line 124. In one example, the counterbalance valve 130 is positioned along the motor outlet line 116 between the relief line 124 and the control valve 118. The counterbalance valve 130 receives pilot pressure from the motor inlet line 114. The counterbalance valve 130 can have a predetermined pilot ratio and a predetermined relief setting. In one example, the relief setting can be set to a value higher than the predetermined relief value of the relief valve 126. In one example, the pilot ratio value can be 8-to-1, and the relief setting can be 3500 pounds per square inch. In this example, the counterbalance valve 130 will move to the full-open position when the pressure at the motor inlet line 114 is 437.5 pounds per square inch (i.e., 3500 psi divided by 8). Hydraulic pressure in the motor outlet line 116 also generates a pilot force that forces the counterbalance valve 130 toward the open position. The pilot force generated by the hydraulic pressure at the outlet 122, in one example, has a 1-to-1 pilot ratio. Thus, the position of the counterbalance valve 130 is controlled by the relief setting of the relief spring that biases the valve 130 toward a closed position, the pilot force generated by pressure at the motor inlet line 114, and the pilot force generated by pressure at the hydraulic motor outlet line 116. In general, the counterbalance valve 130 is fully open when the pump inlet pressure exceeds the relief setting of the counter balance valve divided by the pilot ratio of the counter balance valve, and begins closing when the motor inlet pressure is less than the counter balance valve relief setting divided by the counter balance valve pilot ratio. Generally, the counterbalance valve 130 proportionally controls the outlet pressure at the hydraulic motor outlet 122 when the motor inlet pressure is between 0 psi and 3500 psi (i.e., the relief setting of the counter balance) divided by 8 (i.e., the pilot ratio of the counter balance valve). Of course, pilot ratios and relief settings other than those specifically described herein can be used as well. The primary hydraulic circuit 106 further includes a check valve 132 that allows make-up hydraulic fluid that has been lost through a case drain 134 to be transferred from the case drain 134 into the hydraulic motor inlet when the case drain pressure 134 exceeds the motor inlet 114 pressure by a predetermined spring bias (e.g., 2 psi).

In certain examples, the hydraulic motor 42 can be a fixed displacement hydraulic motor or a variable displacement hydraulic motor. In the case of a variable displacement hydraulic motor, the displacement of the hydraulic motor 42, for each rotation of the drive shaft of the hydraulic motor 42, can be varied. In certain examples, such variation can be achieved through adjustment of the position of a structure such as a swash plate. In one particular example, the hydraulic motor 42 can be operated in two different displacement modes. In one non-limiting example, the hydraulic motor 42 can be operated in a lower displacement mode in which 4.69 cubic inches of hydraulic fluid pass through the motor for each revolution of the motor shaft, and can also be operated in a higher displacement mode in which 7.02 cubic inches of hydraulic fluid pass through the hydraulic motor 42 for each revolution of the motor shaft. As used herein, the term “motor displacement value” means the volume of hydraulic fluid displaced through the motor for each revolution of the motor shaft.

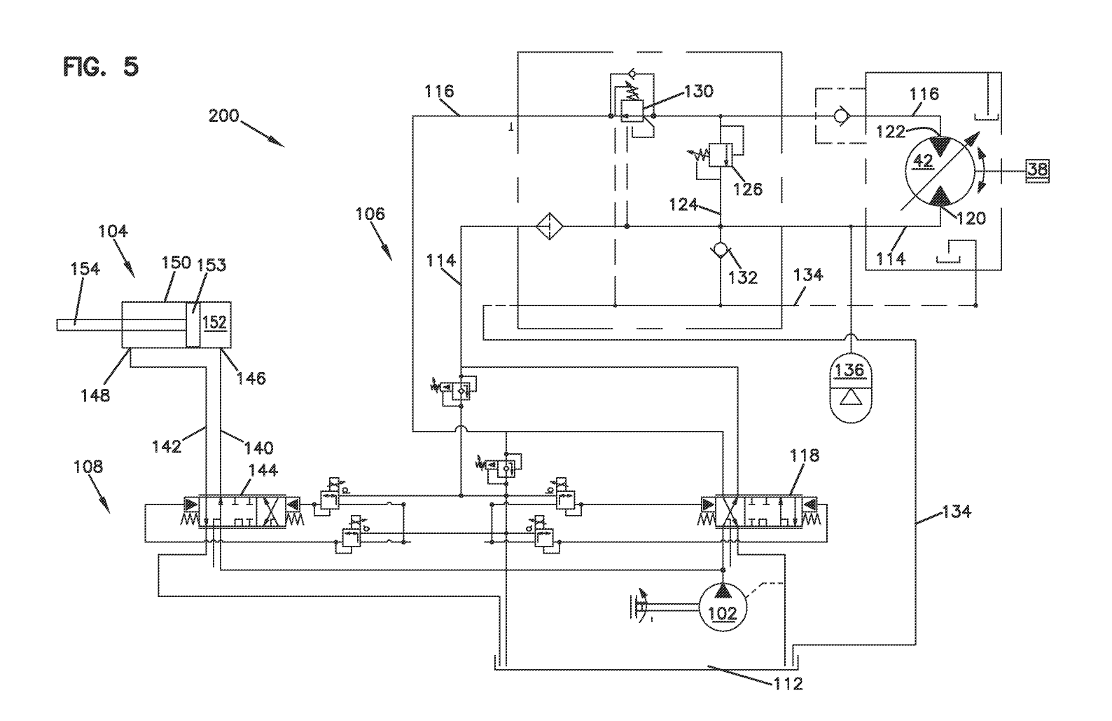

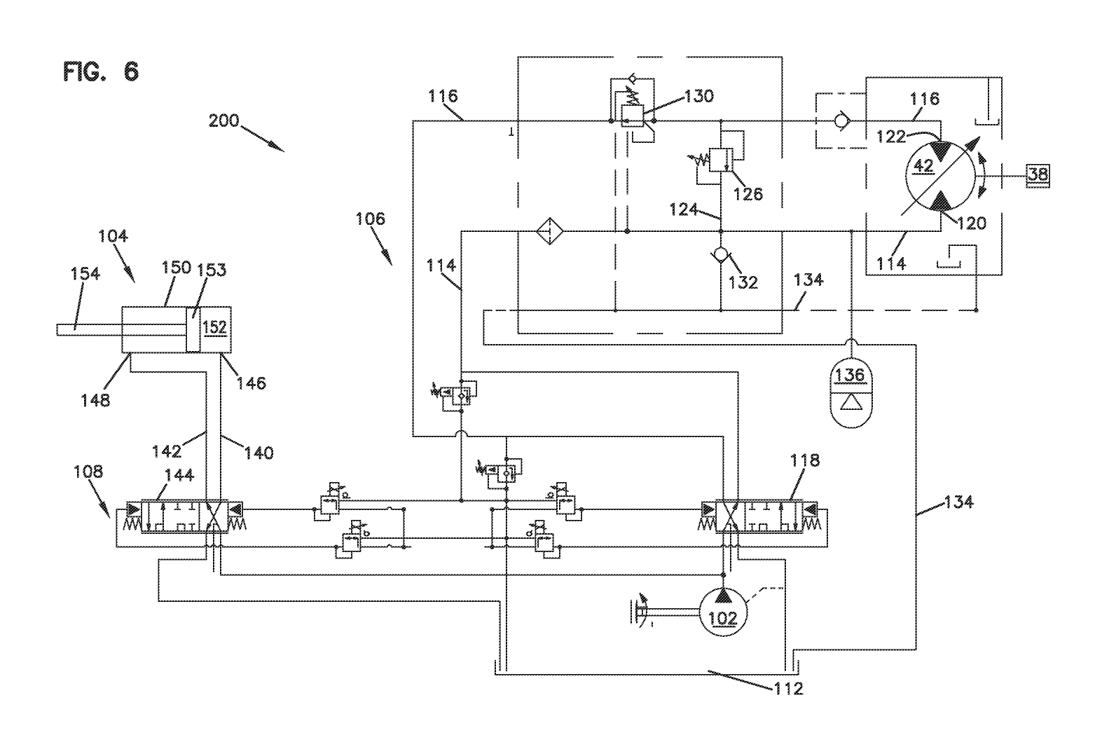

The primary hydraulic circuit 106 further includes an accumulator 136 for accumulating hydraulic fluid under pressure. In certain examples, the accumulator 136 is charged with pressurized hydraulic fluid from the hydraulic pump 102 when the primary hydraulic circuit 106 is being operated in the normal state in which sufficient pressure is provided at the motor inlet line 114 to retain the counterbalance valve 130 in the open position. In certain examples, the accumulator 136 can provide supplemental hydraulic fluid to the motor inlet line 114 during braking to prevent cavitation at the motor inlet 120. The accumulator 136 is discussed in more detail below with respect to FIGS. 5 and 6.

Fluid communication between the hydraulic pump 102 and the primary hydraulic circuit 106 is controlled by a control valve 118. During normal reducing operations, the control valve 118 is moved to the position to enable communication between the hydraulic pump 102 and the hydraulic motor 42. In this position, the high pressure side of the hydraulic pump 102 is fluidly coupled to the motor inlet line 114 of the primary hydraulic circuit 106, and the motor outlet line 116 is fluidly connected to tank 112 (i.e., reservoir). In this configuration, pressurized hydraulic fluid from the hydraulic pump 102 travels through the motor inlet line 114, passes through the hydraulic motor 42 at the inlet 120 to the motor outlet line 116 via outlet 122, thereby driving rotation of the hydraulic motor 42 and the corresponding rotary reducing component 38 (not pictured), and then returns to tank 112 through the motor outlet line 116. In this configuration, the hydraulic pressure at the motor inlet line 114 is high enough to provide sufficient pilot pressure to the counterbalance valve 130 to retain the counterbalance valve in the open position. Thus, the hydraulic pressure at the motor outlet line 116 is substantially below the set point of the relief valve 126. In this way, fluid does not pass through the relief line 124 but instead passes through the counterbalance valve 130 and proceeds to tank 112.

As indicated above, the secondary hydraulic circuit 108 drives one or more actuators 104 such as the hydraulic lift cylinders 34, the hydraulic tilt cylinders 34, or the push bar cylinders 35. The secondary hydraulic circuit 108 includes first and second fluid lines 140, 142 that extend from a control valve 144 to corresponding ports 146, 148 of a cylinder body 150 of the actuator 104. The actuator 104 also includes a piston 152 having a piston head 153 and a piston rod 154. The piston 152 is configured to reciprocate back and forth within the cylinder body 150. The control valve 144 controls fluid communication between the fluid lines 140, 142 and the high pressure side of the hydraulic pump 102, as well as tank 112. When the control valve 144 is in a closed position (see FIGS. 2-4), the first and second fluid lines 140, 142 are disconnected from the hydraulic pump 102, and the tank 112 and the piston 152 are hydraulically locked within the cylinder body 150. The actuator 104 is discussed in more detail with respect to FIGS. 5 and 6.

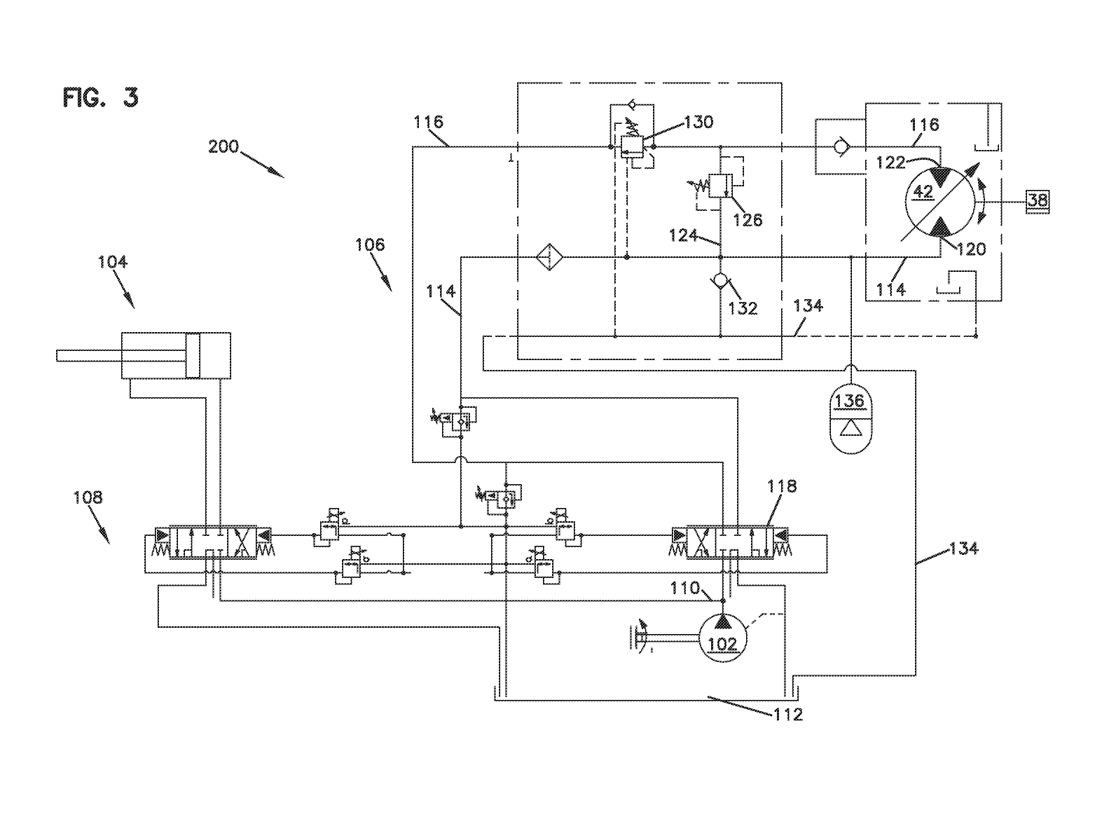

FIG. 3 shows the hydraulic system 200 when hydraulic braking has first been initiated. When it is desired to stop rotation of the rotary reducing component 38, the control valve 118 is moved to a closed position in which the motor inlet line 114 of the primary hydraulic circuit 106 is disconnected from the hydraulic pump 102, and the motor outlet line 116 is disconnected from tank 112. When this occurs, the hydraulic pressure at the motor inlet line 114 decreases to the point where the counterbalance valve 130 closes (as shown at FIG. 3). As the counterbalance valve 130 moves towards the closed position, the inertia of the rotary reducing component 38 causes hydraulic fluid to be pumped through the hydraulic motor 42 from the inlet 120 to the outlet 122. As this occurs, the restriction caused by the closing counterbalance valve 130 causes the hydraulic pressure at the outlet 122 to increase, thereby providing a braking function that resists continued rotation of the hydraulic motor 42. The hydraulic pressure at the motor outlet 122 increases until the pressure reaches the set point of the relief valve 126.

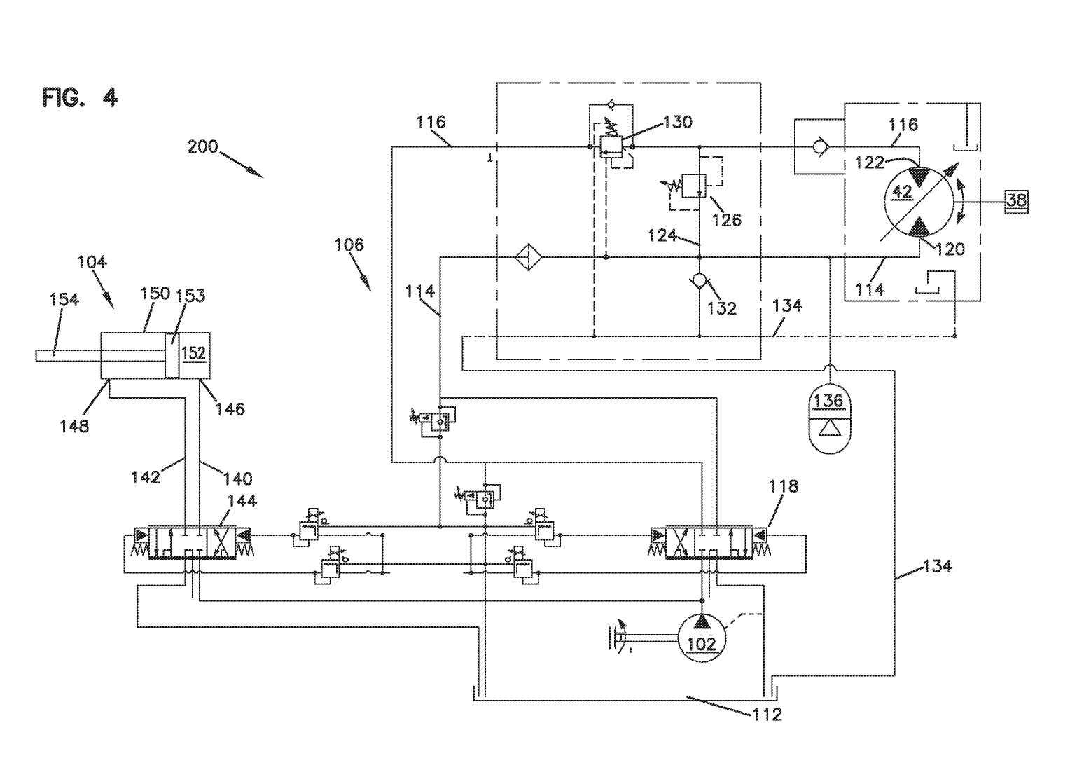

FIG. 4 shows the hydraulic system 200 in a full hydraulic braking mode. When the pressure at the motor outlet 122 reaches the set point of the relief valve 126, the relief valve 126 is forced open (as shown at FIG. 4), thereby allowing hydraulic fluid to flow through the relief line 124 from the motor outlet line 116 to the motor inlet line 114. In this way, the hydraulic pressure at the motor outlet 122 is prevented from exceeding the set point pressure value of the relief valve 126. The pressure set point of the relief valve 126 is selected to provide sufficient resistance to the hydraulic motor 42 such that efficient braking is achieved. During braking, the accumulator 136 and check valve 132 can provide make-up hydraulic fluid to the motor inlet line 114 to prevent cavitation.

FIG. 5 shows the hydraulic system 200 wherein the valve 144 of the secondary hydraulic circuit is in a first open mode. It will be appreciated that a given actuator or actuators can have a maximum actuation volume. As used herein, the maximum actuation volume of an actuator is the maximum volume required to move the actuator or actuators through one stroke or one range of movement. For example, in the case of a hydraulic cylinder such as the depicted actuator 104, the maximum actuation volume represents the volume of hydraulic fluid required to move the piston 152 from a fully retracted orientation to a fully extended orientation. In one non-limiting example, the actuator can be a lift hydraulic cylinder that requires a volume of 0.752 gallons to move the piston from the fully retracted orientation to the fully extended orientation and also requires a volume of 0.3545 gallons to move the piston from the fully extended orientation to the fully retracted orientation. The volume of the piston rod accounts for the difference in the required volumes of hydraulic fluid. For this example, the maximum actuation volume for the actuator is 0.752 gallons since that is the volume required to move the actuator through one full range of movement (e.g., one full extension stroke from fully refracted to fully extended). In the case of a secondary circuit having multiple actuators that are concurrently actuated (e.g., a pair of lift cylinders, a pair of tilt cylinders, or a pair of pusher bar cylinders), the maximum actuation volume for the circuit is the sum of the maximum actuation volumes for the co-acting actuators.

While specific sized actuators have been described, it will be appreciated that aspects of the present disclosure are applicable to actuators of varying sizes. Additionally, it will be appreciated that multiple secondary hydraulic drive circuits can be powered by the hydraulic pump 102. The secondary hydraulic drive circuits can be in parallel with each other and in parallel with the primary hydraulic drive circuit. For example, one hydraulic drive circuit can be provided for the hydraulic lift cylinders 30, and another hydraulic drive circuit can be provided for the hydraulic tilt cylinders 34, and a further hydraulic circuit can be provided for the push bar cylinders 35.

As indicated above, the secondary hydraulic circuit 108 drives one or more actuators 104 such as the hydraulic lift cylinders 30, the hydraulic tilt cylinders 34, or the hydraulic push bar cylinders 35. As indicated above, the control valve 144 controls fluid communication between the fluid lines 140, 142 and the high pressure side of the hydraulic pump 102 as well as tank 112. When the control valve 144 is in a first open position (as shown at FIG. 5), the port 146 is placed in fluid communication with the hydraulic pump 102 via the fluid line 140, and the port 148 is placed in fluid communication with tank 112 via the fluid line 142. This causes the piston 152 to move from a retracted orientation toward an extended orientation.

FIG. 6 shows the secondary hydraulic circuit 108 with the valve 144 in a second open mode. When the control valve 144 is moved to a second open position/mode, the port 148 is placed in fluid communication with the hydraulic pump 102, and the port 146 is placed in fluid communication with tank 112. This causes the piston rod 154 to move from the extended orientation toward the retracted orientation. Piston 152 includes the piston head 153 coupled to the piston rod 154.

In both FIGS. 5 and 6, the rotary reducing component 38 coupled to the hydraulic motor 42 is being rotated at a normal reducing speed. The high pressure side of the hydraulic pump 102 is fluidly coupled to the motor inlet line 114 of the primary hydraulic circuit 106, and the motor outlet line 116 is fluidly connected to tank 112 (i.e., reservoir). In this configuration, pressurized hydraulic fluid from the hydraulic pump 102 travels through the motor inlet line 114, passes through the hydraulic motor 42 at the inlet 120 to the motor outlet line 116 via outlet 122, thereby driving rotation of the hydraulic motor 42 and the corresponding rotary reducing component 38, and then returns to tank 112 through the motor outlet line 116. In certain examples, it is desirable for the hydraulic pump 102 to have a maximum flow rate that relatively closely matches the peak flow demand of the primary load of the primary hydraulic circuit 106. For example, in one non-limiting embodiment, the hydraulic pump 102 can provide a maximum flow rate of 52 gallons per minute, and the hydraulic motor 42 can have a peak flow demand of 45 gallons per minute. In situations where the maximum flow output of the hydraulic pump 102 closely matches the peak flow demand of the hydraulic motor 42, powering of the secondary load while the primary load is being provided with peak flow demand can cause a decrease in pressure at the motor inlet line 114 of the hydraulic drive and primary hydraulic circuit 106 that is sufficiently large to cause the counterbalance valve 130 to at least partially close. When the counterbalance valve 130 at least partially closes, back pressure develops at the motor outlet 122 that causes unintentional braking of the hydraulic motor 42. When the hydraulic motor 42 is unintentionally braked, the rotational velocity of the rotary reducing component 38 decreases thereby negatively impacting performance. To overcome this issue, the accumulator 136 may be sized and configured to have a sufficient volume of hydraulic fluid stored under pressure therein so as to provide supplemental hydraulic fluid pressure and flow to the motor inlet line 114 of the primary hydraulic circuit 106 during a flow diversion event in which hydraulic fluid flow is diverted to the secondary hydraulic circuit 108. Preferably, the accumulator 136 provides sufficient hydraulic fluid flow and pressure to prevent the hydraulic fluid pressure at the motor inlet line 114 from falling below a level where the counterbalance valve 130 begins to close and unintentional braking occurs.

In certain examples, the size of the accumulator 136 can be designed to take into consideration the flow demand of the secondary hydraulic circuit 108. For example, the size of the accumulator 136 can be designed to take into consideration the maximum actuation volume of an actuator or actuators of the secondary hydraulic circuit 108. In one particular example, the accumulator can be sized to have a volume that is at least 20%, 30%, or 40% of the maximum actuation volume of an actuator or actuators powered by the secondary hydraulic circuit 108. The 20%, 30%, and 40% values can be appropriate for certain applications because, in many applications, the actuators are rarely fully extended or refracted during normal reducing operations. Instead, an operator typically uses only a portion of the total range of motion of the actuators during reducing operations (e.g., during mulching operations with a forestry machine). Therefore, by selecting a value that is a certain percentage less than the maximum actuation volume, the system effectively prevents unintentional braking over the vast majority of operational conditions in the field. This represents a balance between factors such as performance, space constraints, and cost. Of course, in other embodiments, larger accumulators can be used.

In the case where the secondary load is a lift circuit including lift cylinders collectively having a maximum actuation volume of 1.504 gallons, the accumulator can be designed having a volume of 0.713 gallons. It will be appreciated that such a system is applicable for use with a pump having a maximum output of 52 gallons per minute and a hydraulic motor having a peak flow demand of 45 gallons per minute. In other examples, the accumulator can have a volume of at least 0.3, 0.4, 0.5, 0.6, or 0.7 gallons depending upon pump size, motor size, secondary circuit demand, performance levels, and other factors. Or course, other sizes could be used as well. Additionally, aspects of the present disclosure are also applicable to systems having other pump sizes, other hydraulic motor sizes, other hydraulic motor to pump ratios, other accumulator sizes, and hydraulic circuit configurations different from those specifically shown herein.

In many applications, hydraulic systems in accordance with the principles of the present disclosure have multiple secondary circuits in parallel with the primary motor circuit, with all of the hydraulic circuits being powered by a common hydraulic pump. In such applications, the accumulator can be sized taking into consideration the maximum actuation volume of the secondary hydraulic circuit having the largest load (i.e., hydraulic fluid volume demand). In other words, the accumulator can be sized taking into consideration the maximum actuation volume of the secondary hydraulic circuit having the largest maximum actuation volume. In the case where only one secondary hydraulic circuit is provided, then the maximum actuation volume of the lone secondary hydraulic circuit represents the maximum actuation volume of the secondary hydraulic circuit having the largest maximum actuation volume.

In other examples, the accumulator 136 can be sized in relation to the maximum displacement value of the hydraulic motor 42. In certain examples, the volume of the hydraulic accumulator 136 can be at least ten, fifteen, or twenty times the maximum displacement value of the hydraulic motor 42.

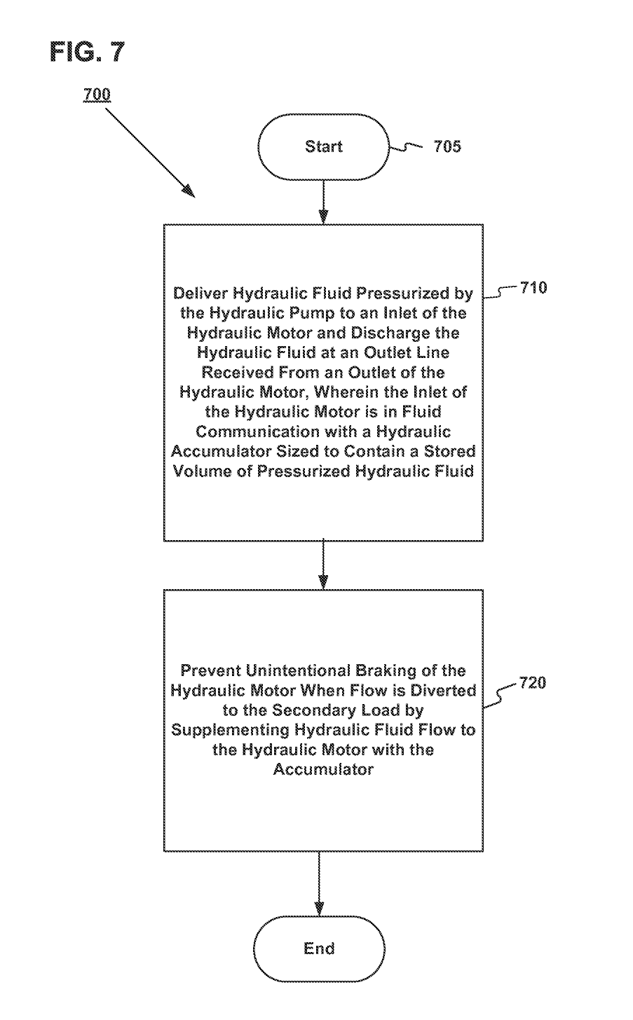

FIG. 7 is a flow chart setting forth the general stages involved in a method 700, consistent with an embodiment of the disclosure, for preventing unintentional braking of a hydraulic motor coupled to a rotary reducing component when a secondary load is applied to a hydraulic pump while the hydraulic pump is concurrently driving the hydraulic motor. Method 700 may be implemented using a hydraulic pump, a rotary reducing component, a primary hydraulic circuit, and a secondary hydraulic circuit as described in more detail above with respect to FIGS. 1-6. Ways to implement the stages of method 700 will be described in greater detail below.

Method 700 may begin at starting block 705 and proceed to stage 710 where hydraulic fluid pressurized by the hydraulic pump may be delivered to an inlet of the hydraulic motor and discharged at an outlet line extending from an outlet of the hydraulic motor. The hydraulic motor 42 is driven by a hydraulic pump 102. The hydraulic motor 42 represents a primary load of the hydraulic system 200. Hydraulic fluid pressurized by the hydraulic pump may be delivered to an inlet of the hydraulic motor and discharged at an outlet line extending from an outlet of the hydraulic motor. The inlet of the hydraulic motor is in fluid communication with a hydraulic accumulator sized to contain a stored volume of pressurized hydraulic fluid.

From stage 710, method 700 may advance to stage 720 where unintentional braking of the hydraulic motor when flow is diverted to the secondary load is prevented by supplementing hydraulic fluid flow to the hydraulic motor with the accumulator. The secondary load can correspond to a lift circuit for raising and lowering a rotary reducing component. The secondary load may include an actuator. The actuator may have a maximum actuation volume. The actuator can be a hydraulic cylinder used to raise and lower a rotary reducing component or to tilt a rotary reducing component.

While aspects of the present disclosure have been shown relating to a material reducing apparatus in the form of a forestry machine, it will be appreciated that the various aspects are also applicable to other types of material reducing machines. Examples of other types of material reducing machines include stump cutters, grinders, tub grinders, horizontal grinders, chippers, or like machines.

What is claimed is:

1. A material reducing apparatus comprising:
a hydraulic pump;
a rotary reducing component;
a primary hydraulic circuit including a hydraulic motor that drives rotation of the rotary reducing component, the primary hydraulic circuit including an inlet line for delivering hydraulic fluid pressurized by the hydraulic pump to an inlet of the hydraulic motor and an outlet line for receiving the hydraulic fluid from an outlet of the hydraulic motor, the primary hydraulic circuit also including at least one braking valve in fluid communication with the outlet line for providing hydraulic braking of the hydraulic motor, and the primary hydraulic circuit including a hydraulic accumulator in fluid communication with the inlet line;
one or more secondary hydraulic circuits in parallel with the primary hydraulic circuit; and
the hydraulic accumulator being sized to contain a stored volume of pressurized hydraulic fluid, the stored volume being equal to at least 20 percent of a maximum actuation volume of the secondary hydraulic circuit having the largest maximum actuation volume.

2. The material reducing apparatus of claim 1, wherein the material reducing apparatus is a forestry machine.

3. The material reducing apparatus of claim 2, wherein the secondary hydraulic circuit having the largest maximum actuation volume is a lift circuit moving a boom used to raise and lower the rotary reducing component.

4. The material reducing apparatus of claim 3, wherein the at least one secondary hydraulic circuit includes a tilt circuit used to tilt the rotary reducing component.

5. The material reducing apparatus of claim 4, wherein the at least one secondary hydraulic circuit includes a pushbar circuit used to raise and lower a pushbar of the forestry machine.

6. The material reducing apparatus of claim 1, wherein the at least one braking valve includes a counterbalance valve having a relief setting, and wherein the counterbalance valve receives pilot pressure from the inlet line.

7. The material reducing apparatus of claim 1, wherein the at least one braking valve includes a relief valve positioned along a relief line that extends between the outlet line and the inlet line.

8. The material reducing apparatus of claim 6, wherein the at least one braking valve further includes a relief valve positioned along a relief line that extends between the outlet line and the inlet line, the relief line connecting to the outlet line at a location upstream from the counterbalance valve, the relief valve having a relief setting that is less than the relief setting of the counterbalance valve.

9. A material reducing apparatus comprising:
a hydraulic pump;
a rotary reducing component;
a hydraulic circuit including a hydraulic motor that drives rotation of the rotary reducing component, the hydraulic circuit including an inlet line for delivering hydraulic fluid pressurized by the hydraulic pump to an inlet of the hydraulic motor and an outlet line for receiving the hydraulic fluid from an outlet of the hydraulic motor, the hydraulic circuit also including at least one braking valve in fluid communication with the outlet line for providing hydraulic braking of the hydraulic motor, and the hydraulic circuit including a hydraulic accumulator in fluid communication with the inlet line, the hydraulic accumulator being sized to contain a stored volume of pressurized hydraulic fluid, the stored volume being at least 10 times as large as a maximum displacement value of the hydraulic motor.

10. The material reducing apparatus of claim 9, further comprising one or more secondary hydraulic circuits selectively powered by hydraulic fluid pressurized by the hydraulic pump.

11. The material reducing apparatus of claim 10, wherein the stored volume is equal to at least 20 percent of a maximum actuation volume of the secondary hydraulic circuit having the largest maximum actuation volume

12. The material reducing apparatus of claim 9, wherein the material reducing apparatus is a forestry machine.

13. The material reducing apparatus of claim 11, wherein the secondary hydraulic circuit having the largest maximum actuation volume is a lift circuit moving a boom used to raise and lower the rotary reducing component.

14. The material reducing apparatus of claim 13, wherein the at least one secondary hydraulic circuit includes a tilt circuit used to tilt the rotary reducing component.

15. The material reducing apparatus of claim 14, wherein the at least one secondary hydraulic circuit includes a pushbar circuit used to raise and lower a pushbar of the forestry machine.

16. The material reducing apparatus of claim 9, wherein the at least one braking valve includes a counterbalance valve having a relief setting, and wherein the counterbalance valve receives pilot pressure from the inlet line.

17. The material reducing apparatus of claim 9, wherein the at least one braking valve includes a relief valve positioned along a relief line that extends between the outlet line and the inlet line.

18. The material reducing apparatus of claim 16, wherein the at least one braking valve further includes a relief valve positioned along a relief line that extends between the outlet line and the inlet line, the relief line connecting to the outlet line at a location upstream from the counterbalance valve, the relief valve having a relief setting that is less than the relief setting of the counterbalance valve.

19. A method for preventing unintentional braking of a hydraulic motor coupled to a rotary reducing component when a secondary load is applied to a hydraulic pump while the hydraulic pump is concurrently driving the hydraulic motor, the method comprising:
delivering hydraulic fluid pressurized by the hydraulic pump to an inlet of the hydraulic motor and discharging the hydraulic fluid at an outlet line received from an outlet of the hydraulic motor, wherein the inlet of the hydraulic motor is in fluid communication with a hydraulic accumulator; and
preventing unintentional braking of the hydraulic motor when flow is diverted to the secondary load by supplementing hydraulic fluid flow to the hydraulic motor with the accumulator.

20. The method of claim 19, wherein the secondary load corresponds to a lift circuit for raising and lowering a rotary reducing component.
